(19) United States
(12) Patent Application Publication
(10) Pub. No.: US 2018/0318785 A1
(43) Pub. Date: Nov. 8, 2018

(54) Improvements in or Relating to Organic Compounds

(71) Applicant: GIVAUDAN SA, Vernier (CH)

(72) Inventors: Emmanuel AUSSANT, Paris (FR); Ian Michael HARRISON, Poissy (FR)

(73) Assignee: GIVAUDAN SA, Vernier (CH)

(21) Appl. No.: 15/770,064

(22) PCT Filed: Nov. 16, 2016
(86) PCT No.: PCT/EP2016/077826

§ 371 Date: Apr. 20, 2018

(30) Foreign Application Priority Data
Nov. 18, 2015 (GB) 1520283.1

(51) Int. Cl. B01J 13/16; B01J 13/20; C08L 75/02

(52) U.S. Cl. CPC B01J 13/16; C08L 2207/53; C08L 75/02; B01J 13/206

(57) ABSTRACT

A microcapsule composition, wherein the shell of the microcapsules comprises at least one polyurea which contains at least one permanent cationic group, which is covalently bonded to the shell and the core comprises at least one perfume ingredient, and wherein the shell of the microcapsules does not contain guanidinium groups.

### BACKGROUND OF THE INVENTION

The present invention relates to microcapsules having a polyurea shell and a lipophilic core containing perfume, an aqueous dispersion of those microcapsules, a process for preparing those microcapsules and the use thereof.

### State of the Art

Microcapsules are spherical objects which consist of a core and a wall material surrounding the core, wherein the core in principal can be a solid, liquid or gaseous component which is surrounded by the solid wall material. For many applications the wall is formed by a polymer material. Microcapsules usually have a volume average diameter from 1 to 1000 μm.

A multitude of shell materials is known for producing the wall of microcapsules. The shell can consist either of natural, semisynthetic or synthetic materials. Natural shell materials are, for example, gum arabic, agar agar, agarose, maltodextrins, alginic acid or its salts, e.g. sodium alginate or calcium alginate, fats and fatty acids, cetyl alcohol, collagen, chitosan, lecithins, gelatin, albumin, shellac, polysaccharides, such as starch or dextran, polypeptides, protein hydrolyzates, sucrose and waxes. Semisynthetic shell materials are inter alia chemically modified celluloses, in particular cellulose esters and cellulose ethers, e.g. cellulose acetate, ethyl cellulose, hydroxypropylcellulose, hydroxypropylmethylcellulose and carboxymethylcellulose, and also starch derivatives, in particular starch ethers and starch esters. Synthetic shell materials are, for example, polymers, such as polyacrylates, polyamides, polyvinyl alcohol, polyvinylpyrrolidone or polyurea.

Depending on the type of shell material and the production process, microcapsules are formed in each case with different properties, such as diameter, size distribution and physical and/or chemical properties.

Polyurea core-shell microcapsules obtained by reaction of two diisocyanates and a polyamine are well known in the art, for example from WO 2011/161229 or WO 2011/160733. According to WO 2011/161229 or WO 2011/160733 the polyurea microcapsules are prepared in presence of polyvinylpyrrolidone (PVP) as a protective colloid.

Polyurea core-shell microcapsules are of great interests for personal care, for a home care, for industrial or institutional or hospital applications, for material protection, for pharmaceutical industry or plant protection. To assure their high benefit in these areas the polyurea core-shell microcapsules must show good deposition on the substrate, such as textile, skin, hair, leaf or other surfaces and adhesion.

It is known that a positive charge implemented the capsule surface enhances the deposition of capsules. Such positively charged molecules present on the capsule wall are often referred as deposition aid.

Several prior art documents discloses cationic microcapsules, in particular polyurea core-shell microcapsules.

WO 01/62376 relates to microcapsules, wherein the surface of these microcapsules has a positive charge. This positive charge is caused either in the wall material itself, e.g. cationic polymer, or coating of the capsule surface with a cationic compound, e.g. quaternary ammonium compounds, cationic polymers or emulsifiers.

WO 2011/123730 relates to a process for coating of a cationic polymer, wherein a sufficient amount of a cationic polymer is added to microcapsules having a negative zeta potential in order to obtain a microcapsule composition which has a positive zeta potential.

WO 2012/004461 relates to cationic functionalized silicone microcapsules. These microcapsules can be obtained by a polycondensation of a precursor of a silsesquioxane polymer followed by cationization using quaternium-80.

WO 2012/107694 relates to polymers selected from polycaprolactone, polylactic acid, ethylcellulose, polymethyl methacrylate and an acrylate-ammonium methacrylate copolymer which were cationized.

WO 2012/138710 and WO 2012/138696 relate to polyacrylate microcapsules for personal cleansing compositions, comprising anionic charged polyacrylate microcapsules, cationic deposition polymer, a detersive surfactant and a carrier. The polyacrylate microcapsules were coated with an anionic emulsifier obtaining anionic charged polyacrylate microcapsules. Those microcapsules were combined with a cationic deposition polymer obtaining a premix. The premix is added to a detersive surfactant and a carrier resulting in a personal cleansing composition.

US 2012/0148644 relates to polyurethane or polyurea microcapsules which may be modified with further a polymer which is selected from an amphoteric and cationic polymer, such as polyquaternium-6, polyquaternium-47, polyvinylamine and its copolymers with vinylformamide.

U.S. Pat. No. 8,426,353 relates to perfume-containing microcapsules with a polyurea wall. Those microcapsules are obtained by a reaction of polyisocyanates with a colloidal stabilizer in form of an aqueous solution of a polyvinyl alcohol and of a cationic copolymer of vinylpyrrolidone and of a quaternized vinylimidazol. The cationic deposition aids are non-covalently bound to the capsule shell and thus it can be easily removed from the capsule wall.

US 20060216509 relates to microcapsules, wherein the walls of the microcapsules are a reaction product of guanidine and polyisocyanate. The obtained capsules are cationizable by acidation or alkylation. The resulting microcapsules contain latent cationic groups. That means that the microcapsules have a cationic character under limited conditions e.g. at a low pH-value. Microcapsules with a permanent cationic charge are obtained by a post quaternization of amine functionalities using dimethyl sulfate as a quaternizing agent. Dimethyl sulfate is known as an extremely toxic, cancerogenic, mutagenic and corrosive agent. It is banned for many applications. US 20060216509 describes in example 7 cationic capsules that are donated as permanently. These may be obtained by a reaction of dimethyl sulfate with a capsule dispersion. The capsule dispersion can be prepared by mixing a solution of polyvinyl alcohol and a solution of polyisocyanate. After adding guanidinium carbonate solution to this mixture the mixture was gradually heated to 70° C. and a solution of pentaethylenehexamine in water was added. The obtained dispersion was cooled to room temperature. Afterwards, dimethyl sulfate was added to the capsule dispersion and the mixture was heated to 50° C. and stirred at this temperature for two hours. Finally, the dispersion was cooled to room temperature and stabilized by addition of a thickener. The inventors of the present invention discovered that under the conditions disclosed in US 20060216509 it is not possible obtaining permanently cationic capsules.

It is a continuing demand for delivery systems, which should allow a controlled delivery of hydrophilic compounds under defined application conditions and show good deposition on the substrate at the same time.

It is an object of the present invention to provide a perfume-containing microcapsule composition, which can be implemented with a permanent cationic charge on the wall surface. Further, it is an object of the present invention to provide a perfume-containing microcapsule composition for the use as or in a personal care, air care, home care, or laundry care composition,

Surprisingly, these objects could be achieved by microcapsules, wherein the shell of the microcapsules comprises at least one polyurea which contains at least one permanent cationic group, which is covalently bonded to the shell and the core comprises at least one perfume ingredient.

It has further surprisingly been found that these objects could be achieved by a process for the preparation of microcapsule composition, wherein the shell of the microcapsules comprises at least one polyurea which contains at least one cationic group and the core comprises at least one perfume ingredient comprising the steps of:
providing an aqueous solution comprising at least one protective colloid,
providing at least one polyisocyanate in a lipophilic phase containing at least one perfume ingredient,
mixing the aqueous solution, the polyisocyanate and the lipophilic phase to form an emulsion,
adding an aqueous solution containing at least one polyfunctional amine to initiate the polyaddition reaction,
forming a dispersion of microcapsules by heating the obtained mixture to a temperature of at least 50° C., and
adding at least one α,β-unsaturated carbonyl compound having at least one permanent cationic group.

### SUMMARY OF THE INVENTION

The present invention relates to a microcapsule composition, wherein the shell of the microcapsules comprises at least one polyurea which contains at least one cationic group covalently bound to the shell, and the core comprises at least one perfume ingredient

In a specific embodiment the present invention further relates to a microcapsule composition, wherein the shell of the microcapsules comprises at least one polyurea which contains at least one cationic group covalently bound to the shell, and the core comprises at least one perfume ingredient, and wherein the shell of the microcapsules does not contain guanidinium groups.

The present invention further relates to a microcapsule composition defined above and in the following in form of an aqueous dispersion of the microcapsules.

The present invention further relates to microcapsules defined above and in the following by drying a dispersion of microcapsules.

The present invention further relates to the preparation of microcapsule composition or microcapsules, wherein the shell of the microcapsules comprises at least one polyurea which contains at least one permanent cationic group covalently bound to the shell, and the core comprises at least one perfume ingredient comprising the steps of:
a) providing a premix (I) comprising at least one protective colloid in an aqueous solution,
b) providing a premix (II) comprising at least one polyisocyanate and at least one lipophilic component,
c) mixing premix (I) and premix (II) until an emulsion (III) is formed,
d) adding an aqueous solution (IV) containing at least one polyfunctional amine to the emulsion formed in step c),
e) forming a dispersion of microcapsules by heating the mixture obtained in step d) to a temperature of at least 50° C., and
f) adding at least one α,β-unsaturated carbonyl compound having at least one permanent cationic group.

The present invention further relates to microcapsules obtainable by the process according to the invention.

The present invention further relates to microcapsules obtained by the process according to the invention.

The present invention further relates to the use of microcapsule composition as defined above and in the following or of microcapsules as defined above and in the following in
a personal care composition, an air care composition, a home care composition or a laundry care composition.

The present invention further relates to the use of microcapsules or microcapsule composition defined above and in the following for finishing of textiles, papers or nonwovens.

### DETAILED DESCRIPTION OF THE INVENTION

The volume average particle size is measured by light scattering measurements using a Malvern 2000S instrument and the Mie scattering theory. The principle of the Mie theory and how light scattering can be used to measure capsule size can be found, for example in H. C. van de Hulst, Light scattering by small particles. Dover, N.Y., 1981. The primary information provided by static light scattering is the angular dependence of the light scattering intensity which, in turn, is linked to the size and shape of the capsules. However, in a standard operation method, the size of a sphere having a size equivalent to the size of the diffracting object, whatever the shape of this object is, is calculated by the Malvern proprietary software provided with the apparatus. In case of polydisperse samples, the angular dependence of the overall scattering intensity contains information about the size distribution in the sample. The output is a histogram representing the total volume of capsules belonging to a given size class as a function of the capsule size, whereas an arbitrary number of 50 size classes is typically chosen.

Experimentally, a few drops of the dispersion containing about 10% of capsules are added to a circulating stream of degased water flowing through a scattering cell. The angular distribution of the scattering intensity is measured and analyzed by Malvern proprietary software to provide the average size and size-distribution of the capsules present in the sample. In the context of the present invention, the percentiles D10, D 50 and D 90 are used as characteristics of the capsule size distribution, whereas D 50 corresponds to the median(=average) of the distribution. In the present invention the term “particle size” means “volume particle size”.

### Zeta Potential:

Zeta Potential was measured using Zetasizer Nano Z. Before measurement capsules were prepared as follow:

Capsule dispersion was filtered off, washed 5 times with distilled water and re-dispersed again.

Then 2 g of the dispersion was added to 8 g of a buffer solution at pH 7.

A laser with a wavelength of 633 nm was used for the measurements.

A stable dispersion in the sense of the present invention denotes a dispersion of polyurea microcapsules which, upon visible inspection, shows no sign of phase separation, such as creaming, settling, precipitation or coagulation when stored for a period of two weeks at a temperature of 50° C.

The term “aqueous solution” or “aqueous dispersion” is used equivalent and means in the sense of the invention denotes water and mixtures of water with at least one partly water-miscible organic solvent. Suitable organic solvents are e.g. C₁-C₄-alkanols. The C₁-C₄-alkanols are preferably selected from among methanol, ethanol, n-propanol, isopropanol and n-butanol. Mixtures of at least one C₁-C₄-alkanol with water preferably comprise from 0.1 to 99.9% by weight, particularly preferably from 0.2 to 50% by weight, in particular from 0.3 to 10% by weight of at least one C₁-C₄-alkanol, based on the total weight of the mixture. In a special embodiment the aqueous solution consists of water.

In the sense of the present invention the term permanent cationic groups denotes a cationic group that does not lose properties due to the change of the pH-value. Permanent cationic groups can be prepared by reacting of amino groups or phosphine groups with an alkylating agent such as dialkylsulfates or alkylhalides. In contrast thereto, the protonation of an amino group or phosphine group leads to a non-permanent cationic group.

According to the invention, compounds used to modify the microcapsules with permanent cationic groups are monomers, in particular α,β-unsaturated carbonyl compounds having at least one permanent cationic group, which are employed for the formation of the microcapsules or microcapsule composition according to the invention. Suitable monomers bearing at least one permanent cationic group are mentioned in the following.

The terms “α,β-unsaturated carbonyl compound having at least one permanent cationic group” and “quaternization/quaternized product of an α,β-unsaturated carbonyl compound” herein are used synonymously.

### Microcapsules

A first aspect of the invention relates to a microcapsule composition and microcapsules.

Said microcapsules are characterized in that the shell contains permanent cationic groups that are covalently bonded to the shell. In order to obtain microcapsules with permanent cationic groups that are covalently bonded to the shell first the shell of the microcapsules is formed by a conventional polyaddition reaction of at least one polyisocyanate and at least one polyfunctional amine. The thus obtained shell material is then subjected to a polymer analogous reaction with a α,β-unsaturated carbonyl compound bearing at least one cationic group. This reaction of pre-formed shell material with said α,β-unsaturated carbonyl compound leads to the formation of microcapsules, wherein the shell contains permanent cationic groups that are covalently bonded to the shell.

The cationic groups, which are covalently bonded to the shell of the microcapsule are preferably nitrogen-containing or phosphorus-containing positively charged groups.

Preferably, the nitrogen-containing groups are tertiary amino groups or quaternary ammonium groups, in particular quaternary ammonium groups. Preferably, the phosphorus-containing groups are tertiary phosphino groups or quaternary phosphonium groups, in particular quaternary phosphonium groups. In particular preferred are microcapsules with quaternary ammonium groups as cationic groups.

Charged cationic groups can be produced from the amine nitrogens or phosphine phosphorus by quaternization with an alkylating agents. Examples of these include carboxylic acids, such as lactic acid, or mineral acids, such as phosphoric acid, sulphuric acid and hydrochloric acid, and examples of alkylating agents include C₁-C₄-alkyl halides or sulfates, such as ethyl chloride, ethyl bromide, methyl chloride, methyl bromide, dimethyl sulfate and diethyl sulfate. A protonation, based on a reaction of the amino group with a salt forming agent, e.g. acids, does not lead to permanent cationic groups in the sense of the invention. It is possible that such protonation is an additional step to the quaternization. The quaternization of the compounds used to modify the shell of the microcapsules with permanent cationic groups employed for the formation of the microcapsules according to the invention is affected before the microcapsules are formed.

Another important parameter of the microcapsules composition of the invention is volume average diameter. The microcapsules according to the invention have a volume average diameter of 2 to 90 μm, particularly 5 to 60, and more particularly 10 to 30.

The core of the microcapsules is typically 60 to 97% by weight and the shell of the microcapsule is typically 40 to 3% by weight, based on the total weight of the microcapsule, preferably the core is 70 to 95% by weight and the shell is 30 to 5% by weight, and in particular the core is 80 to 90% by weight and the shell is 20 to 10% by weight bases total weight of the microcapsule.

The microcapsules according to the invention typically have an amount of polyurea of at least 50% by weigt, preferably at least 55% by weight, with reference to the total weight of the shell.

The microcapsules according to the invention must show good deposition on the substrate and adherence to the substrate in order to assure the benefit of these capsules in the area of personal care, home care, industrial or institutional or hospital applications, material protections, pharmaceutical industry or plant protection. The positive charge of the permanent cationic groups which are covalently bonded to the shell of the microcapsules according to the invention enhances the deposition of capsules. In particular, the adherence of the mircrocapsules is increased, if the surface of the substrate is negatively charged.

Theretofore microcapsule according to the invention with a zeta potential from 6 to 100 mV, especially from 15 to 80 mV, and in particularly from 15 to 55 mV, are preferred.

### Core Ingredients

The microcapsule core comprises at least one perfume ingredient.

The at least one perfume ingredient may be selected from any of those perfume ingredients described in standard reference known to the perfumer including texts such as the book by S. Arctander, Perfume and Flavor Chemicals, 1969, Montclair, N.J., USA, or its more recent versions, or in other works of a similar nature, as well as in the abundant patent literature in the field of perfumery.

In an embodiment of the invention, if the perfume composition contains an aldehyde perfume ingredient, it is preferred if the perfume also contains a non-aromatic cyclic perfume ingredient.

In a more particular embodiment of the present invention, the microcapsule core contains an aldehyde perfume ingredient, a non-aromatic cyclic perfume ingredient, and an alkyl salicylate and/or a 2,2,2-trisubstituted acetal, wherein said acetal has the general formula

R₁R₂R₃C—CH (OR₄)(OR₅)

wherein R₁ is a saturated or unsaturated alkyl or aromatic residue having at least 4 carbon atoms, more preferably at least 5 carbon atoms and most preferably at least 6 carbon atoms, but not more than 10 carbon atoms; R₂ and R₃ are independently selected from a saturated or unsaturated alkyl residue having at least on carbon atom; and R₄ and R₅ are independently selected from either a methyl group and/or an ethyl group.

In a more particular embodiment of the invention the encapsulated perfume comprises, in addition to the aldehyde perfume ingredient, a non-aromatic cyclic perfume ingredient and an alkyl salicylate.

In a still more particular embodiment of the invention the microcapsule core comprises, in addition to the aldehyde perfume ingredient, a non-aromatic cyclic perfume ingredient, an alkyl salicylate and a 2,2,2-trisubstituted acetal, hereinabove defined.

The term “cyclic perfume ingredient” as used herein refers to a molecule useful as a perfume ingredient, which contains within its chemical structure a series of atoms that forms a closed ring. That ring may be aromatic or aliphatic. It may be mono- or poly-cyclic, and it may contain hetero-atoms. The ring may bear substituents or it may be unsubstituted.

The aldehyde perfume ingredient may be any aldehyde useful in perfumery or as a flavourant. The skilled person in the art of perfumery has available a palette of ingredients containing aldehyde functionality, and these ingredients are contemplated in the present invention as representing aldehyde perfume ingredients. The aldehyde may be an aliphatic aldehyde, a cycloaliphatic aldehyde, and acyclic terpene aldehyde, a cyclic terpene aldehyde, or an aromatic aldehyde.

More particularly, the aldehydes include, but are not limited to, the following group of aldehydes, wherein the CAS numbers are provided in parentheses. Herein, where trivial or non-systematic names are employed for fragrance ingredients, the skilled person will understand that these names and CAS numbers are intended to also include synonyms based on more formal systems of nomenclature, such as IUPAC:

DECANAL (112-31-2), 2-METHYL DECANAL (ALDEHYDE C-11 (19009-56-4), 10-UNDECEN-1-AL (112-45-8), UNDECANAL (112-44-7), DODECANAL (112-54-9), 2-METHYL UNDECANAL (110-41-8), HEPTANAL (111-71-7), OCTANAL (124-13-0), GREEN HEXANAL (5435-64-3), NONANAL (124-19-6), UNDECENAL MIXTURE (1337-83-3), (Z)-4-DECENAL (21662-09-9), (E)-4-DECENAL (65405-70-1), 9-DECENAL (39770-05-3), ISOVALERIANIC ALDEHYDE (590-86-3), AMYL CINNAMIC ALDEHYDE 122-40-7), METHYL CINNAMIC ALDEHYDE (101-39-3), METHYL PHENYL HEXENAL (21834-92-4), PHENYL PROPIONIC ALDEHYDE (104-53-0), PARA TOLYL ALDEHYDE (104-87-0), PARA ANISALDEHYDE (123-11-5), BENZALDEHYDE (100-52-7), CYCLAL C (68039-49-6), TRICYCLAL (68039-49-6), CYCLOMYRAL (68738-94-3), ISOCYCLOCITRAL (1335-66-6), MACEAL (68259-31-4), SAFRANAL (116-26-7), HELIOTROPINE (120-57-0), HEXYL CINNAMIC ALDEHYDE (101-86-0), BOURGEONAL (18127-01-0), CINNAMIC ALDEHYDE (104-55-2), CUMINIC ALDEHYDE (122-03-2), CYCLAMEN ALDEHYDE (103-95-7), CYCLOHEXAL (31906-04-4), FENNALDEHYDE (5462-06-6), FLORALOZONE (67634-15-5), FLORHYDRAL (125109-85-5), HYDRATROPIC ALDEHYDE (93-53-8), LILIAL (80-54-6), MEFRANAL (55066-49-4), MYRALDENE (37677-14-8), SILVIAL (6658-48-6), TRIFERNAL (16251-77-7), 2-TRIDECENAL (7774-82-5), DUPICAL (30168-23-1), SCENTENAL (86803-90-9), PRECYCLEMONE B (52475-86-2), VERNALDEHYDE (66327-54-6), HEXANAL (66-25-1), ADOXAL (141-13-9), CALYPSONE (929253-05-4), CETONAL (65405-84-7), CITRAL (5392-40-5), CITRONELLAL (106-23-0), CITRONELLYL OXYACETALDEHYDE (7492-67-3), DIHYDRO FARNESAL (32480-08-3), HYDROXYCITRONELLAL (107-75-5), MELONAL (106-72-9), METHOXYMELONAL (62439-41-2), NONADIENAL (557-48-2), ONCIDAL (54082-68-7), PINOACETALDEHYDE (33885-51-7), TETRAHYDRO CITRAL (5988-91-0), TROPIONAL (1205-17-0), ETHYL VANILLIN (121-32-4), VANILLIN (121-33-5).

When assigning perfume ingredients to categories, a perfume ingredient that contains both aldehyde functionality and a ring is considered to be an aldehyde perfume ingredient for the purpose of the present invention, and not a cyclic perfume ingredient.

The perfume contained in the microcapsule core may contain up to about 6% by weight of aldehyde perfume ingredients. More particularly, the perfume may contain aldehyde perfume ingredients within the range of 0.01% to 6% by weight, more particularly still 0.01 to 5.5%, still more particularly 0.01 to 5%, still more particularly 0.01 to 4.5%, still more particularly 0.01 to 4.0%, still more particularly 0.01 to 3.5%, still more particularly 0.01 to 3%, still more particularly 0.01 to 2%, still more particularly 0.01 to 1% by weight based on the weight of the microcapsule.

Non-aromatic cyclic perfume ingredients include, but are not limited to, cyclic esters, ketones, ketals and alcohols. Particularly useful non-aromatic cyclic perfume ingredients in the present invention are cyclic esters. Examples of useful cyclic esters include:

ACETYLATED CLOVE OIL TERPENES (68425-19-4), AGRUMEX (88-41-5), ALLYL CYCLOHEXYL PROPIONATE (2705-87-5), AMBER CORE (139504-68-0), AMBREINE (8016-26-0), AM BREINOL (73138-66-6), AMBRETTOLIDE (28645-51-4), AM BRINOL (41199-19-3), AMBROFIX (6790-58-5), APHERMATE (25225-08-5), AZARBRE (68845-36-3), BICYCLO NONALACTONE (4430-31-3), BOISIRIS (68845-00-1), BORNEOL (507-70-0), BORNYL ACETATE LIQUID (125-12-2), PARA BUTYL CYCLOHEXANOL (98-52-2), PARA BUTYL CYCLOHEXYL ACETATE (32210-23-4), CAMONAL (166301-22-0), CAMPHOR SYNTHETIC (76-22-2), LAEVO CARVONE (6485-40-1), CASHMERAN (33704-61-9), CEDRENE (11028-42-5), CEDRENOL (28231-03-0), CEDROL (77-53-2), WOODY EPDXIDE (71735-79-0), CEDRYL ACETATE CRYSTALS (77-54-3), CEDRYL METHYL ETHER (19870-74-7), CELERY KETONE (3720-16-9), CETALOX (3738-00-9), CIVETTONE (542-46-1), CONIFERAN (67874-72-0), CORANOL (83926-73-2), COSMONE (259854-70-1), CYCLOGALBANATE (68901-15-5), CYCLOHEXYL ETHYL ACETATE (21722-83-8), CYPRISATE (23250-42-2), DAMASCENONE (23696-85-7), ALPHA DAMASCONE (24720-09-0), BETA DAMASCONE (23726-92-3), DELTA DAMASCONE (57378-68-4), DELTA DECALACTONE (705-86-2), GAMMA DECALACTONE (706-14-9), DECATONE (34131-98-1), DIHYDRO AM BRATE (37172-02-4), BETA DIHYDRO IONONE (17283-81-7), DIHYDRO JASMONE (1128-08-1), DELTA DODECALACTONE (713-95-1), DODECALACTONE GAMMA (2305-05-7), DUPICAL (30168-23-1), ETHYL SAFRANATE (35044-59-8), ETHYLENE BRASSYLATE (105-95-3), EUCALYPTOL (470-82-6), ALPHA FENCHONE (7787-20-4), FENCHYL ACETATE (13851-11-1), FENCHYL ALCOHOL (1632-73-1), FLOROCYCLENE (68912-13-0), FLOROSA (63500-71-0), FLORYMOSS (681433-04-5), FOLENOX (26619-69-2), FOLROSIA (4621-04-9), FRESKOMENTHE (14765-30-1), FRUITATE (80623-07-0), GALBANONE PURE (56973-85-4), GARDOCYCLENE (67634-20-2), GEORGYWOOD (185429-83-8), GIVESCONE (57934-97-1), GLYCOLIERRAL (68901-32-6), GRISALVA (68611-23-4), GYRANE (24237-00-1), HABANOLIDE (111879-80-2), HEDIONE (24851-98-7), HEPTALACTONE GAMMA (105-21-5), HERBANATE (116126-82-0), HERBAVERT (67583-77-1), HERBOXANE (54546-26-8), BETA IONONE (8013-90-9), IRISANTHEME (1335-46-2), ALPHA IRISONE (8013-90-9), ALPHA IRONE (79-69-6), IRONE F (54992-91-5), ISO E SUPER (54464-57-2), ISOJASMONE B 11 (95-41-0), ISOLONGIFOLANONE (23787-90-8), ISOMENTHONE DL (491-07-6), ISOPULEGOL (89-79-2), ISORALDEINE 40, 70 and 90 (1335-46-2), JASMACYCLENE (5413-60-5), JASMATONE (13074-65-2), JASMOLACTONE (32764-98-0), CIS JASMONE (488-10-8), JASMONYL (18871-14-2), KARANAL (117933-89-8), KEPHALIS (36306-87-3), LAITONE (4625-90-5), LIGANTRAAL (68738-99-8), MAYOL (13828-37-0), MENTHONE (89-80-5), METAMBRATE (72183-75-6), METHYL CEDRYL KETONE (32388-55-9), GAMMA METHYL DECALACTONE (7011-83-8), METHYL DIHYDRO ISOJASMONATE (37172-53-5), METHYL EPI JASMONATE (39924-52-2), METHYL TUBERATE (33673-62-0), MUSCENONE (82356-51-2), MUSCONE (541-91-3), ETHYLENE DODECANOATE (54982-83-1), MUSK LACTONE (3391-83-1), MYRALDYL ACETATE (72403-67-9), NECTARYL (95962-14-4), NIMBEROL (70788-30-6), NIRVANOLIDE (329925-33-9), NOOTKATONE (4674-50-4), NOPYL ACETATE (128-51-8), DELTA OCTALACTONE (698-76-0), GAMMA OCTALACTONE (104-50-7), OKOUMAL (131812-67-4), OPALAL (62406-73-9), ORIVONE (16587-71-6), OXYOCTALINE FORMATE (65405-72-3), PIVACYCLENE (68039-44-1), PLICATONE (41724-19-0), POIRENATE (2511-00-4), QUINTONE (4819-67-4), RHUBOFIX (41816-03-9), RHUBOFLOR (93939-86-7), ROSE OXIDE CO (16409-43-1), ROSE OXIDE LAEVO (3033-23-6), ROSSITOL (215231-33-7), SAFRALEINE (54440-17-4), SANDELA (66068-84-6), SPIRAMBRENE (121251-67-0), SPIROGALBANONE (224031-70-3), SUPERFIX (3910-35-8), THIBETOLIDE (106-02-5), TIMBEROL (70788-30-6), TRIMOFIX 0 (144020-22-4), DELTA UNDECALACTONE (710-04-3), GAMMA VALERO LACTONE (108-29-2), VELOUTONE (65443-14-3), VELVIONE (37609-25-9), VERDALIA (27135-90-6), VERDOL (13491-79-7), VERTOFIX COEUR (32388-55-9), VETIKOL ACETATE (68083-58-9), VETIVERYL ACETATE (68917-34-0), VETYNAL (57082-24-3).

Useful alkyl salicylates include AMYL SALICYLATE (2050-08-0), ETHYL SALICYLATE (118-61-6), HEXENYL-3-CIS SALICYLATE (65405-77-8), HEXYL SALICYCLATE (6259-76-3), ISOBUTYL SALICYLATE (87-19-4), ISOBUTYL SALICYLATE (87-19-4), KARMAFLOR (873888-84-7), METHYL SALICYLATE (119-36-8).

Useful 2,2,2-substituted acetals include METHYL PAMPLEMOUSSE (67674-46-8), AMAROCIT B (72727-59-4), NEROLIACETAL (99509-41-8).

The non-aromatic cyclic perfume ingredients and alkyl salicylates, independently of each other, may be present in amounts of about 10% or greater by weight based on the total weight of perfume employed in the preparation of the microcapsules, and more particularly 15% or greater, more particularly 20% or greater, more particularly 25% or greater, still more particularly 30% or greater, more particularly 33% or greater, for example 20 to 99.99%, or 25 to 99.99%, or 25 to 99.99%, or 30 to 99.99%, or 33 to 99.99%.

In a particular embodiment of the present invention aldehyde perfume ingredients may present in an amount of about 1% to 6% by weight, more particularly 2% to 5.5% by weight, still more particularly 3% to 5% by weight; and non-aromatic cyclic perfume ingredients and/or alkyl salicylates perfume ingredients are independently present in amounts of more than 30% by weight, still more particularly more than 33% by weight.

In another particular embodiment aldehyde perfume ingredients may be present in an amount of about 1% to 6% by weight, more particularly 2% to 5.5% by weight, still more particularly 3% to 5% by weight; non-aromatic cyclic perfume ingredients and/or alkyl salicylates perfume ingredients independently may be present in amounts between 10% and 33% by weight.

In yet another particular embodiment aldehyde perfume ingredients may be present in an amount of about 1% to 6% by weight, more particularly 2% to 5.5% by weight, still more particularly 3% to 5% by weight; non-aromatic cyclic perfume ingredients and alkyl salicylates perfume ingredients independently may be independently present in amounts between 10% and 33% by weight and the 2,2,2-substituted acetals may be present in amounts of more than 25% by weight, more particularly more than 30% by weight, still more particularly more than 33% by weight.

In addition to the specific perfume ingredients referred to herein above, the microcapsules may contain all manner of additional perfume ingredients that are useful in perfumery applications. In general terms, additional perfume ingredients will belong to chemical classes as varied as alcohols, ketones, esters, ethers, acetates, terpene hydrocarbons, nitrogenous or sulphurous heterocyclic compounds and essential oils, which can be of natural or synthetic origin. Many of these additional perfume ingredients are in any case listed in reference texts such as the book by S. Arctander, Perfume and Flavor Chemicals, 1969, Montclair, N.J., USA, or its more recent versions, or in other works of a similar nature, as well as in the abundant patent literature in the field of perfumery. It is also understood that these ingredients may also be compounds known to release in a controlled manner various types of perfuming compounds.

As is generally known in the art, perfume retention during microcapsule formation, as well as stability towards leakage once a capsule is formed, is promoted through the use of high amounts of perfume ingredients having a relatively high C log P. In particular, at least about 50%, more particularly more than about 60%, and still more particularly more than about 80% of ingredients should have a C log P of about 2.5 or greater, and more particularly 3.3 or greater, and still more particularly 4.0 or greater. Use of such perfume ingredients is regarded as helpful in reducing diffusion of perfume through a microcapsule shell and into a consumer product base under specific time, temperature, and concentration conditions.

The values of C log P of perfume ingredients have been reported in many databases, including the Pomona 92 database, available from Daylight Chemical Information Systems, Inc., Daylight CIS, Irvine, Calif.

In addition to perfume ingredients, solvents may be employed in the microcapules of the present invention. Solvent materials are hydrophobic materials that are miscible in the perfume ingredients, and which have little or no odour in the quantities employed.

Solvents commonly employed have high C log P values, for example greater than 6 and even greater than 10. Solvents include triglyceride oil, mono and diglycerides, mineral oil, silicone oil, diethyl phthalate, polyalpha olefins, castor oil and isopropyl myristate.

US2011071064 is concerned with polyurea capsules for use in personal care applications. It is particularly concerned with means of manipulating the shell properties in order to manipulate the stability and release profile of the capsules. It is stated therein, that a solvent should be employed in the core in an amount greater than 10%, more particularly greater than 30%, and still more particularly greater than 70% by weight based on the weight of the perfume composition.

However, the applicant surprisingly found that it is possible to employ substantially no solvent material in the core of the microcapsule. Indeed, applicant found that it is possible to prepare an encapsulated perfume compositions wherein the microcapsule core is composed entirely of perfume ingredients and no solvents. Solvent-free encapsulated perfumes may be employed, in particular, when the perfume ingredients making up the core material are formed have limited water solubility. In particular, the core material should be formed with a large proportion of perfume ingredients having a solubility in water of 15,000 ppm or less, more particularly 5000 ppm or less, and still more particularly 3000 ppm or less. More particularly, at least 60%, more particularly at least 70% and still more particularly at least 80% of perfume ingredients should have a solubility in water of 15,000 ppm or less, more particularly 5000 ppm or less, and still more particularly 3000 ppm or less.

Avoiding the use of a solvent in the microcapsule core is generally advantageous in terms of reducing costs and having regard to the environmental considerations.

### Process

The present invention relates also to a process for the preparation of a microcapsule composition or microcapsules as defined above.

Within the context of the present invention, the microcapsules have a shell that is prepared by reacting at least one polyisocyanate with at least one polyfunctional amine which leads to a pre-formed shell material followed by a polymer analogous reaction with an αβ-unsaturated carbonyl compound having at least one permanent cationic group forming microcapsule, wherein the shell contains permanent cationic groups that are covalently bonded to the shell. In a special embodiment, the shell is the reaction product of at least two different polyisocyanates with at least one polyfunctional amine which leads to a pre-formed shell material followed by a polymer analogous reaction with an αβ-unsaturated carbonyl compound having at least one permanent cationic group.

The reaction is a polyaddition between the isocyanate groups and the amine groups and optional further groups, capable of reacting with NCO groups which leads to the formation of polyurea linkages. The polyfunctional amine may in addition to at least one primary or secondary amine group contain at least one further group, capable of reacting with NCO groups, e.g. at least one OH group. Reaction of NCO groups with amine groups leads to the formation of urea groups. Reaction of NCO groups with OH groups leads to the formation of urethane groups. Compounds containing only one active hydrogen atom per molecule lead to a termination of the polymer chain and can be employed as regulators. Compounds containing more than two active hydrogen atoms per molecule lead to the formation of branched polyureas.

The compounds which contain at least one active hydrogen atom per molecule are usually employed in a molar excess of active hydrogen atoms relative to the NCO groups of the polyisocyanate. The amount of polyfunctional amines which is introduced is usually in a molar excess, relative to the stoichiometric amount needed to convert the free isocyanate groups. Suitable polyisocyanates, polyfunctional amines, optional components that take part in the polyaddition reaction, lipophilic components, protective colloids, stabilizing agent and further additives, are mentioned below.

As mentioned before, the shell material of the microcapsules is subjected to a polymer analogous reaction with the αβ-unsaturated carbonyl compound having at least one permanent cationic group, which leads to the formation of microcapsules, wherein the shell of the microcapsules contains at least one permanent cationic group, which is covalently bonded to the shell. Consequently, the shell material contains permanent cationic groups due to the reaction of the αβ-unsaturated carbonyl compound having at least one permanent cationic group. The reaction may be performed by a Michael addition of a suitable αβ-unsaturated carbonyl compound having at least one permanent cationic group. Suitable compounds are defined in the following.

In one preferred embodiment, the process is carried out as follows:
a) providing a premix (I) comprising at least one protective colloid in an aqueous solution,
b) providing a further premix (II) comprising lipophilic phase containing at least one perfume ingredient and first polyisocyanate (A),
c) mixing premix (I) and premix (II) until an emulsion is formed and adding a second polyisocyanate (B) to the emulsion obtained in step c),
d) adding an aqueous solution (IV) containing at least one polyfunctional amine to the emulsion formed in step c),
e) forming a dispersion of microcapsules by heating the mixture obtained in step d) to a temperature of at least 50° C. and
f) adding at least one αβ-unsaturated carbonyl compound having at least one permanent cationic group.

In one preferred embodiment, the process is carried out as follows:
a) providing a premix (I) comprising at least one protective colloid in an aqueous solution and adjusting the pH in a range of from 5 to 12,
b) providing a further premix (II) comprising lipophilic phase containing at least one perfume ingredient and first polyisocyanate (A),
c) mixing premix (I) and premix (II) until an emulsion is formed and adding a second polyisocyanate (B) to the emulsion obtained in step c) and adjusting the pH of the resulting emulsion in a range of from 5 to 10,
d) adding an aqueous solution (IV) containing at least one polyfunctional amine to the emulsion formed in step c),
e) forming a dispersion of microcapsules by heating the mixture obtained in step d) to a temperature of at least 50° C. and
f) adding at least one αβ-unsaturated carbonyl compound having at least one permanent cationic group.

### Step a)

Premix (I) provided in step a) contains an aqueous solvent. Suitable solvents are water and mixtures of water with at least one water-miscible organic solvent. Suitable water-miscible organic solvent are mentioned above. Preferably, the solvent is essentially water.

The aqueous solution provided in step a) comprises at least one protective colloid.

During the reaction between the polyisocyanates and the polyfunctional amines, a protective colloid may be present. Protective colloids are polymer systems which, in suspensions or dispersions, prevent a clumping together (agglomeration, coagulation, flocculation) of the emulsified, suspended or dispersed components. During solvation, protective colloids bind large amounts of water and in aqueous solutions produce high viscosities depending on the concentration. Within the context of the process described herein, the protective colloid may also have emulsifying properties. The aqueous protective colloid solution is likewise preferably prepared with stirring.

Preferably, premix (I) comprises at least one protective colloid selected from polyvinylpyrrolidones, polyvinyl alcohols, maleic-vinyl copolymers, sodium lignosulfonates, maleic anhydride/styrene copolymers, ethylene/maleic anhydride copolymers, copolymers of ethylene oxide, propylene oxide and ethylenediamine, fatty acid esters of polyethoxylated sorbitol, sodium dodecylsulfate, hydroxyalkylcellulose and mixtures thereof. More preferably, premix (I) comprises at least one protective colloid selected from polyvinylpyrrolidones, polyvinyl alcohols and mixtures thereof. Polyvinylpyrrolidones are particularly preferred.

Standard commercial polyvinylpyrrolidones have molar masses in the range from ca. 2500-750000 g/mol which are characterized by stating the K values and have—depending on the K value—glass transition temperatures from 130 to 175° C. They are supplied as white, hygroscopic powders or as aqueous solution.

The polyvinylpyrrolidones used in premix (I) preferably have a K value (determined at 25° C. in a 1% by weight aqueous or ethanolic solution) of at least 10, particularly preferably of at least 20, more preferably of at least 80. A preferred range is between 65 and 90 for the K value.Determination of the K value is described in H. Fikentscher “Systematik der Cellulosen auf Grund ihrer Viskosität in Lösung”, Cellulose-Chemie 13 (1932), 58-64 and 71-74, and Encyclopedia of Chemical Technology, Vol. 21, 2^{nd} edition, 427-428 (1970).

Suitable commercially available polyvinylpyrrolidones are the Kollidon® trademarks from BASF SE. Preferred polyvinylpyrrolidones useful in the practice of the present invention are available in three grades: Kollidon®.RTM. 25 (BASF Corporation), Kollidon®.RTM. 90 (BASF Corporation), and Kollidon®.RTM. CI-M (BASF Corporation). Kollidon®.RTM. 25 has a weight average molecular weight of 28000-34000. Kollidon®.RTM. 90 has a molecular weight average of 1000000-1500000. Further commercially available polyvinylpyrrolidones are Kollidon® 12 which has a weight average molecular weight of 2000-3000, Kollidon 17 which has a weight average molecular weight of 7000-11000 and Kollidon 30 which has a weight average molecular weight of 44000-54000.

The term polyvinyl alcohols includes homopolymers or copolymers.

Polyvinyl alcohols homopolymers are obtained by hydrolysis of polyvinyl carboxylates, e.g. of polyvinyl acetate. Consequently, the term homopolymers denotes also polyvinyl alcohols with a degree of hydrolyses <100%, in particular having a degree of hydrolysis in the range of 85 to 99.9%, especially in the range from 85 to 95%. These homopolymers still comprise ester groups and hydroxyl groups. The degree of hydrolysis can be determined by techniques well known in the art, for example, according to DIN 53401.

As used herein, the term “polyvinyl alcohol copolymer” means a polymer polymer of vinyl alcohol/vinyl acetate with comonomers.

The polyvinyl alcohol copolymers contain addition comonomers, that is, comonomers that are polymerized with a vinyl ester in a first step, followed by hydrolysis of the ester groups to form the copolymer of polyvinyl alcohol in a second step. Copolymers may be formed by radical polymerization of vinyl acetate and comonomers in a manner known per se. Polyvinyl alcohol copolymers may contain unsaturated hydrocarbons as comonomers. These hydrocarbons may be modified with charged or non-charged functional groups. Particular comonomers include, but are not limited to:
unsaturated hydrocarbons with 2 or 3 carbon atoms and no functional groups, e.g. ethylene;
unsaturated hydrocarbons having 2 to 6 carbon atoms and non-charged functional groups, such as hydroxyl groups, e.g. buten-1,4-diol;
unsaturated hydrocarbons having anionic groups, such as carboxyl, and/or sulphonic acid groups;
unsaturated hydrocarbons having cationic groups, such as quaternary ammonium groups.

Particular copolymers of polyvinyl alcohol include those having a degree of hydrolysis of 85 to 99.9%, and more particularly 85 to 95%; and which contain 0.1 to 30 mol % of comonomers containing anionic groups as mentioned above; or
0.1 to 30 mol % of comonomers containing cationic groups as mentioned above; or
0.1 to 30 mol of comonomers with unsaturated hydrocarbons having 2 to 6 carbon atoms and non-charged functional groups, especially two hydroxyl groups,
   wherein mol % is based on the vinyl acetate/comonomer polymerization mixture.

Suitable copolymers of polyvinyl alcohol and comonomers having 1,2 diol structures are described in EP 2 426 172 and EP 2 648 211 which are herein incorporated by reference.

The protective colloid can be, but does not have to be, a constituent of the capsule shell.

The protective colloid may be, but does not have to be, a constituent of the capsule shell with amounts from 0.01 to at most 3% by weight, but preferably in the range from 1 to 5% by weight and in particular from 1.5 to 3% by weight, based on the weight of the capsules, being possible here.

Combinations of two or more different protective colloids may also be employed in the present invention.

In a further preferred embodiment, the protective colloid employed in step a) comprises or consists of at least one polyvinylpyrrolidone, preferably with a K value between 65 and 90.

Premix (I) may also contain at least one emulsifier. Emulsifiers include non-ionic, cationic, anionic and zwitterionic surfactants.

Suitable non-ionic surfactants are selected from the group consisting of products of the addition of 2 to 30 mol ethylene oxide and/or 0 to 5 mol propylene oxide onto linear C₆₋₂₂ fatty alcohols, onto C₁₂₋₂₂ fatty acids, onto alkyl phenols containing 8 to 15 carbon atoms in the alkyl group and onto alkylamines containing 8 to 22 carbon atoms in the alkyl group; alkyl oligoglycosides containing 8 to 22 carbon atoms in the alkyl group and ethoxylated analogs thereof; addition products of 1 to 15 mol ethylene oxide onto castor oil and/or hydrogenated castor oil; addition products of 15 to 60 mol ethylene oxide onto castor oil and/or hydrogenated castor oil; partial esters of glycerol and/or sorbitan with unsaturated, linear or saturated branched fatty acids containing 12 to 22 carbon atoms and/or hydroxycarboxylic acids containing 3 to 18 carbon atoms and addition products thereof onto 1 to 30 mol ethylene oxide; partial esters of polyglycerol (average degree of self-condensation 2 to 8), polyethylene glycol (molecular weight 400 to 5,000), trimethylolpropane, pentaerythritol, sugar alcohols (for example sorbitol), alkyl glucosides (for example methyl glucoside, butyl glucoside, lauryl glucoside) and polyglucosides (for example cellulose) with saturated and/or unsaturated, linear or branched fatty acids containing 12 to 22 carbon atoms and/or hydroxycarboxylic acids containing 3 to 18 carbon atoms and addition products thereof onto 1 to 30 mol ethylene oxide; mixed esters of pentaerythritol, fatty acids, citric acid and fatty alcohol and/or mixed esters of fatty acids containing 6 to 22 carbon atoms, methyl glucose and polyols, preferably glycerol or polyglycerol, mono-, di- and trialkyl phosphates and mono-, di- and/or tri-PEG-alkyl phosphates and salts thereof, wool wax alcohols, polysiloxane/polyalkyl/polyether copolymers and corresponding derivatives, block copolymers, for example Polyethyleneglycol-30 Dipolyhydroxystearate; polymer emulsifiers, for example Pemulen types (TR-1, TR-2) of Goodrich; polyalkylene glycols and glycerol carbonate and ethylene oxide addition products.

### Step b

Premix (II) provided in step b) comprises lipophilic phase containing at least one perfume ingredient and at least one polyisocyanate.

Premix (II) is generally in liquid form. Preferably, premix (II) contains no or only a minor amount of solid components. In the sense of the invention, a minor amount means that the amount of solid components is at the most 5% by weight, preferably at the most 1% by weight, more preferably at the most 0.1% by weight, based on the total weight of premix (II). In particular, premix (II) contains no solid components.

Premix (II) optionally contains at least one organic solvent. An organic solvent is particularly used if the mixture of the employed polyisocyanates and the employed lipophilic components is not liquid under the conditions of process step b).

The lipophilic phase, as defined above, are in general components which have only limited solubility in water. This includes hydrophobic components that are liquid under the encapsulation conditions and mixtures of hydrophobic components, wherein the mixture is liquid under the encapsulation conditions.

Further, premix (II) comprises at least one polyisocyanate.

Isocyanates are N-substituted organic derivatives (R—N═C═O) of isocyanic acid (HNCO) tautomeric in the free state with cyanic acid. Organic isocyanates are compounds in which the isocyanate group (—N═C═O) is bonded to an organic radical. Polyfunctional isocyanates are compounds with two or more (e.g. 3, 4, 5, etc.) isocyanate groups in the molecule.

Preferably, the polyisocyanate employed in step b) comprises at least one difunctional isocyanate. In a special embodiment, the polyisocyanate employed in step b) is exclusively selected from difunctional isocyanates, the allophanates, isocyanurates, uretdiones or carbodiimides of difunctional isocyanates and mixtures thereof.

In general, suitable polyisocyanates are all aromatic, alicyclic and aliphatic isocyanates, provided they have at least two reactive isocyanate groups.

Preferably, the polyisocyanate component has an average content of 2 to 4 NCO groups. Preference is given to using diisocyanates, i.e. esters of isocyanic acid with the general structure O═C═N—R′—-N═C═O, where R′ is an aliphatic, alicyclic or aromatic radical.

Suitable polyisocyanates are chosen from compounds with 2 to 5 isocyanate groups, isocyanate prepolymers with an average number of from 2 to 5 isocyanate groups and mixtures thereof. These include, for example, aliphatic, cycloaliphatic and aromatic di-, tri- and higher polyisocyanates.

Preferably, the polyisocyanate is selected from hexamethylene diisocyanate (HDI), tetramethylene diisocyanate, ethylene diisocyanate, 1,2-diisocyanatododecane, 4-isocyanatomethyl-1,8-octamethylene diisocyanate, triphenylmethane-4,4′,4″-triisocyanate, 1,6-diisocyanato-2,2,4-trimethylhexane, 1,6-diisocyanato-2,4,4-trimethylhexane, isophorone diisocyanate (=3-Isocyanatmethyl-3,5,5-trimethylcyclohexylisocyanat, 1-lsocyanato-3-isocyanatomethyl-3,5,5-trimethylcyclohexan, IPDI), 2,3,3-trimethylhexamethylene diisocyanate, 1,4-cyclohexylene diisocyanate, 1-methyl-2,4-diisocyanatocyclohexane, dicyclohexylmethane-4,4′-diisocyanate (=methylene-bis(4-cyclohexylisocyanate)), 1,3-phenylene diisocyanate, 1,4-phenylene diisocyanate, 2,4- and 2,6-toluylene diisocyanate and isomer mixtures thereof, 1,5-naphthylene diisocyanate, 2,4′- and 4,4′-diphenylmethane diisocyanate (MOi), mixtures of diphenylmethane diisocyanates and more highly polycyclic homologs of diphenylmethane diisocyanate (polymeric MDI), hydrogenated 4,4′-diphenylmethane diisocyanate (H12M DI), xylylene diisocyanate (XDI), tetramethylxylol diisocyanate (TMXDI), 4,4′-dibenzyl diisocyanate, 4,4′-diphenyldimethylmethane diisocyanate, di -and tetraalkyldiphenylmethandiisocyanates, dimer fatty acid diisocyanates, chlorinated and brominated diisocyanates, 4,4′-diisocyanatophenylperfluoroethane, tetramethoxybutane-1,4-diisocyanate, phosphorus-containing diisocyanates, sulfur-containing diisocyanares, anionically modified polyisocyanates, polyethylene oxide-containing isocyanate, oligomers of the afore-mentioned polyisocyanates that contain urethane, allophanate, isocyanurate, uretdione, carbodiimide or biuret groups, and mixtures thereof.

Suitable chlorinated and brominated polyisocyanates comprise polyisocyanates with reactive halogen atoms. Preferably, the chlorinated and brominated polyisocyanate is selected from 1-chloromethylphenyl 2,4-diisocyanate, 1-bromomethylphenyl 2,6-diisocyanate, 3,3-bischloromethyl ether 4,4′-diphenyldiisocyanate.

Suitable sulfur-containing polyisocyanates are obtained, for example, by reacting 2 mol of hexamethylene diisocyanate with 1 mol of thiodiglycol or dihydroxydihexyl sulfide.

Preferably, the anionically modified polyisocyanates contain at least two isocyanate groups and at least one anionic or aniogenic group in the molecule. Suitable anionic or aniogenic groups are carboxylic acid groups, sulfonic acid groups, phosphonic acids groups and the salts thereof. Preferably, the anionically modified polyisocyanates contain one or more than one sulfonic acid group or a salt thereof in the molecule. Suitable salts are e.g. sodium, potassium and ammonium salts. Ammonium salts are especially preferred. Preferred bases to neutralize the anionic groups are selected from, for example, ammonia, NaOH, KOH, C₁-C₆-alkylamines, preferably n-propylamine and n-butylamine, dialkylamines, preferably diethylpropylamine and dipropylmethylamine, trialkylamines, preferably triethylamine and triisopropylamine, C₁-C₆-alkyldiethanolamines, preferably methyl- or ethyldiethanolamine and di-C₁-C₆-alkylethanolamines.

Preferred anionically modified polyisocyanates are obtained by reaction of polyisocyanates with 2-(cyclohexylamino)-ethanesulfonic acid and/or 3-(cyclohexylamino)-propanesulfonic acid.

More preferred anionically modified polyisocyanates are obtained by reaction of polyisocyanates with 2-(cyclohexylamino)-ethanesulfonic acid and/or 3-(cyclohexylamino)-propanesulfonic acid, wherein the polyisocyanate is delected from hexamethylene diisocyanate, tetramethylene diisocyanate, isophorone diisocyanate, dicyclohexylmethane-4,4′-diisocyanate, 2,4- and 2,6-toluylene diisocyanate and isomer mixtures, diphenylmethane diisocyanates, biurets, allophanates and/or isocyanurates of the afore-mentioned polyisocyanates.

Suitable anionically modified polyisocyanates are described in US 2004/0034162 which is incorporated herein by reference.

Preferred anionically modified polyisocyanates have
an average isocyanate functionality of at least 1.8,
a content of isocyanate groups (calculated as NCO; molecular weight=42) of 4.0 to 26.0 wt. %,
a content of sulfonate groups (calculated as SO₃; molecular weight=80) of 0.1 to 7.7 wt. % and
optionally a content of ethylene oxide units bonded within polyether chains (calculated as C₂H₂O; molecular weight=44) of 0 to 19.5 wt. %, wherein the polyether chains contain a statistical average of 5 to 55 ethylene oxide units.

Preferred anionically modified polyisocyanates are selected from anionically modified hexamethylene diisocyanate, anionically modified hexamethylene diisocyanate, anionically modified isocyanurates of hexamethylene diisocyanate and mixtures thereof.

Preferred commercially available anionically modified polyisocyanates are modified isocyanurates of hexamethylene diisocyanate sold by Bayer AG under the trademark Bayhydur®, e.g. Bayhydur® XP. It has the following formula:

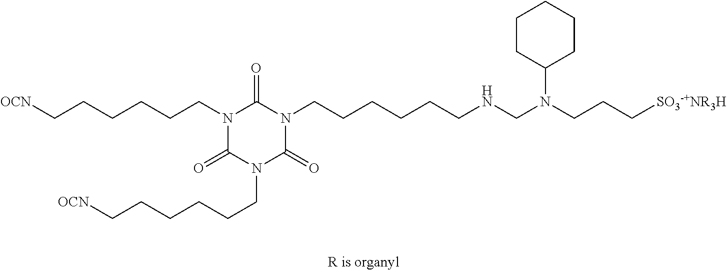

Suitable polyethylene oxide-containing polyisocyanates have at least two isocyanate groups and at least one polyethylene group. Polyethylene oxide-containing isocyanates are described, e.g. in U.S. Pat. No. 5,342,556. These isocyanates are self-emulsifying in water, which may be advantageous within the context of the present process since it may be possible to dispense with a separate emulsifying step.

The polyisocyanate preferably comprises at least one polyisocyanate, selected from hexamethylene diisocyanate, tetramethylene diisocyanate, isophorone diisocyanate, dicyclohexylmethane-4,4′-diisocyanate, 2,4- and 2,6-toluylene diisocyanate and isomer mixtures thereof, 2,4′- and 4,4′-diphenylmethane diisocyanate, the biurets, allophanates and/or isocyanurates of the afore-mentioned polyisocyanates, anionically modified polyisocyanates, and mixtures thereof.

In a special embodiment, the polyisocyanate employed in step b) comprises two structurally different polyisocyanates (A) and (B).

In particular polyisocyanate employed in step b) comprises at least one nonionic polyisocyanate (A) and at least one anionically modified isocyanate (B), wherein the anionically modified isocyanates (B) preferably contains at least one sulfonic acid group in the molecule.

Suitable polyisocyanates of type (A) are nonionic polyisocyanates bearing at least two NCO groups.

Preferably, polyisocyanates of type (A) are selected from hexamethylene diisocyanate, tetramethylene diisocyanate, dicyclohexylmethane-4,4′-diisocyanate, 2,4- and 2,6-toluylene diisocyanate and isomer mixtures thereof, 2,4′- and 4,4′-diphenylmethane diisocyanate and isomer mixtures thereof, the biurets, allophanates and/or isocyanurates of the afore-mentioned polyisocyanates or mixtures thereof.

In particular, isocyanates of type (A) are selected from hexamethylene diisocyanate, isophorone diisocyanate, dicyclohexylmethane-4,4′-diisocyanate, the isocyanurate of hexamethylene diisocyanate or mixtures thereof.

Preferred commercially available isocyanates of type (A) are hexamethylene diisocyanate sold by Bayer AG under the trademark Desmodur® N3200™.

Also preferred commercially available isocyanates of type (A) are isophorone diisocyanate sold by Bayer AG under the trademark Desmodur® N3300™.

The second polyisocyanate of type (B) is structurally different from the isocyanate of type (A). Preferably, the polyisocyanate of type (B) bears at least two NCO groups and at least one functional group, selected from anionic/anionogenic groups, polyethylene groups and combinations thereof.

Preferably, however, only anionically modified isocyanates are used as component (B) in the present process.

Preferably, the polyisocyanate (B) is selected from in each case anionically modified hexamethylene diisocyanate, tetramethylene diisocyanate, dicyclohexylmethane-4,4′-diisocyanate, 2,4- and 2,6-toluylene diisocyanate and isomer mixtures thereof, 2,4′- and 4,4′-diphenylmethane diisocyanate and isomer mixtures thereof, the biurets, allophanates and/or isocyanurates of the afore-mentioned polyisocyanates or mixtures thereof.

In particular, isocyanates of type (B) are selected from in each case anionically modified hexamethylene diisocyanate, isophorone diisocyanate, dicyclohexylmethane-4,4′-diisocyanate, the isocyanurate of hexamethylene diisocyanate or mixtures thereof.

In a preferred embodiment, the isocyanates of type (A) are selected from hexamethylene diisocyanate, isophorone diisocyanate, dicyclohexylmethane-4,4′-diisocyanate, the isocyanurate of hexamethylene diisocyanate or mixtures thereof and the isocyanates of type (B) are selected from anionically modified hexamethylene diisocyanate, anionically modified isophorone diisocyanate, anionically modified dicyclohexylmethane-4,4′-diisocyanate, the anionically modified isocyanurate of hexamethylene diisocyanate or mixtures thereof.

In a further preferred embodiment, the premix (II) comprises at least one nonionic polyisocyanate (A) and at least one anionically modified isocyanate (B), wherein the anionically modified diisocyanates (B) preferably contain at least one sulfonic acid group in the molecule.

In particular, the polyisocyanate of type (A) is hexamethylene diisocyanate, dicyclohexylmethane-4,4′-diisocyanate or a mixture thereof and the polyisocyanate of type (B) is anionically modified hexamethylene diisocyanate, anionically modified isocyanurate of hexamethylene diisocyanate, anionically modified dicyclohexylmethane-4,4′-diisocyanate or mixtures thereof.

The weight ratio of the polyisocyanates (A) and (B) is preferably in the range from 10:1 to 1:10, more preferably in the range from 5:1 to 1:5 and in particular in the range from 3:1 to 1:1.

It is also possible to use mixtures of different isocyanates of types (A) and (B). Besides the isocyanates (A) and (B), further isocyanates can also additionally be used in the process according to the invention.

### Step c)

In step c) the premix (I) and premix (II) are mixed until an emulsion (III) is formed. In order to form an emulsion (III) in the present process, the premix (I) and premix (II) are emulsified by processes known to the person skilled in the art, e.g. by introducing energy into the mixture through stirring using a suitable stirrer until the mixture emulsifies.

A preferred embodiment is a process, wherein
a target range for the volume average diameter of the droplets of the hydrophobic (discontinuous phase) of the resulting emulsion (III) is predefined,
the actual volume average diameter of the droplets of the hydrophobic phase in the mixture of premix (I) and premix (II) is determined,
the speed of the stirrer and/or the time of stirring of the mixture are adjusted until the target value volume average diameter of the droplets of the hydrophobic phase of the resulting emulsion (III) is reached in order to obtain the predefined target volume average diameter of the droplets of the hydrophobic phase.

It has been found favourable if the mixture of premix (I) and premix (II) in step c) is stirred with a speed of the stirrer of 200 rpm to 1200 rpm, preferably 400 to 800 rpm. Those values are especially favorable if MIG stirrer is used.

It has been found favourable if the mixture of premix (I) and premix (II) is stirred vigorously in streaming conditions with Reynolds numbers above 10³ for a time period of only a several seconds up to a several minutes. The mixture in step c) is stirred for 1 to 120 minutes, preferably 2 minutes to 60 minutes, especially 5 to 30 minutes.

Suitable devices for controlling the volume average diameter of the droplets of discontinuous phase of the resulting emulsion are known to those skilled in the art. Such devises are based, for example, on light scattering measurements. Suitable light scattering measurements are known to those skilled in the art and are commercially available from, for example, Malvern Instruments, e.g. Malvern autosizer.

The rate of stirring of the mixture of premix (I) and premix (II) in step c) is adjusted to influence the size of droplets of hydrophobic phase in the aqueous phase. After a period of vigorous stirring, an emulsion is obtained, in which the premix (II) is dispersed as tiny droplets in the aqueous solution of premix (I). The droplets of the discontinuous phase of the emulsion has a volume average diameter of 1 to 88 μm.

The mixture of premix (I) and premix (II) is stirred vigorously. Preferred stirrer are MIG stirrer, propellers stirrer, paraviscs stirrer, INTERMIG stirrer and isojet stirrer.

The pH is preferably adjusted using aqueous bases, preference being given to using sodium hydroxide solution (e.g. 5% strength by weight). Preferably the pH of emulsion (III) is adjusted from 3 to 12, in particular between 4 to 10, and more particular in the range from 5 to 10.

In a preferred embodiment, premix (II) comprises a polyisocyanate (A) which is mixed with premix (I) until an emulsion is formed. Another polyisocyanate (B) is added to the obtained emulsion (III). In another preferred embodiment, the polyisocyanate (A) and polyisocyanare (B) are both contained in the premix (I). Preferably, first the isocyanate (A) is contained in the premix (II), and an emulsion with premix (I) is formed and the second the isocyanate (B) is added to the emulsion (III).

### Step d)

The aqueous solution (IV) comprises at least one polyfunctional amine. Suitable amines are mentioned below.

In the sense of the invention, the term polyfunctional amine denotes amines that comprise at least two groups capable of reacting with NCO groups, wherein at least one of the groups capable of reacting with NCO groups is a primary or secondary amino group. When the polyfunctional amine contains only one primary or secondary amino group, it will contain one or more additional functional groups that are capable of reacting with NCO groups in a polymerisation reaction. Suitable are in principle active hydrogen atom containing groups. The groups of the polyfunctional amines that are reactive toward NCO groups are preferably chosen from hydroxyl groups and primary and secondary amino groups.

The polyfunctional amine is preferably selected from diamines, aminoalcohols, polymeric polyamines, melamines, urea, hydrazines and mixtures thereof.

Suitable diamines are, for example, 1,2-ethylenediamine, 1,3-propylenediamine, 1,4-diaminobutane, 1,5-diaminopentane, 1,6-diaminohexane, 1,3-diamino-1-methylpropane, 1,4-diaminocyclohexane, piperazin and mixtures thereof.

Suitable amino alcohols are, for example, 2-aminoethanol, 2-(N-methylamino)ethanol, 3-aminopropanol, 4-aminobutanol, 1-ethylaminobutan-2-ol, 2-amino-2-methyl-1-propanol, 4-methyl-4-aminopentan-2-ol, etc.

Suitable polymeric polyamines are in principle linear or branched polymers that have at least two primary or secondary amino groups. Additionally, these polymers can have tertiary amino groups in the polymer chain.

In a preferred embodiment, the polyfunctional amine comprises or consists of at least one polyethylenimine.

In the processes according to the invention as a polyfunctional amine polyethyleneimines, especially with a molecular weight of at least 500 g/mol, preferably from 600 to 30 000 or 650 to 25 000 g/mol and in particular from 700 to 10 000 g/mol or 850 to 5000 g/mol, are preferably used.

Preference is given to polymeric polyamines having a weight-average molecular weight of at least 500 g/mol. More preferred are polymeric polyamines having a weight-average molecular weight of from 500 to 1 000 000, in particular from 650 to 2 000 000, especially from 700 to 100 000, more especially from 800 to 50 000.

The polymeric polyamine is preferably selected from polyalkyleneimines, polyvinylamines, polyetheramines, etc. More preferably, the polymeric polyamine is selected from polyalkyleneimines, in particular polyethyleneimines.

Preferred polyethyleneimines are diethylenetriamine, triethylenetetramine, tetraethylenepentamine, ethylenepropylenetriamine, trisaminopropylamine and higher polyethyleneimines.

In a preferred embodiment, the polymeric polyamine is selected from polyethyleneimines having a weight average molecular weight of at least 300 g/mol.

Suitable polyethylenimines contain the following repeat units

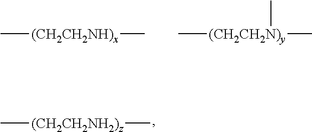

wherein

x is from 8 to 1500, preferably from 10 to 1000;

y is from 0 to 10, preferably from 0 to 5, especially 0;

z is 2+y.

Preferred polyethyleneimines are linear polyethyleneimines, wherein x is from 8 to 1500, y is 0 and z is 2.

Preferred commercially available polyethylenimines are sold by BASF SE under the trademark Lupasol® and the Jeffamine® trademarks from Huntsman, particularly Lupasol TM PR8515.

In the processes according to the invention, polyethyleneimines with a molecular weight of at least 500 g/mol, preferably from 600 to 30 000 or 650 to 25 000 g/mol and in particular from 700 to 5000 g/mol or 850 to 2500 g/mol, are preferably used.

It is preferred to use polyethylenimine: Isocyanate compounds (A) or (A) and (B) in a weight ratio of 1:1 to 1:5, especially 1:2 to 1: 3.

### Step e)

The polyaddition reaction in step e) is generally performed at a temperature of at least 50° C., preferably 60° C., more preferably in a range of from 75° C. to 90° C. and in particular 85° C. to 90° C., in order to ensure sufficiently rapid reaction progress.

Here, it may be preferred to increase the temperature continuously or in stages (e.g. in each case by 10° C.) the reaction is essentially complete. Afterwards, the dispersion may cooled down to room temperature.

The reaction time typically depends on the reaction amount and temperature used. The period of time for the polyaddition reaction is ranging from a few minutes to several hours. Usually, microcapsule formation is established between ca. 60 minutes to 6 h or up to 8 h at the temperatures defined above.

### Step f)

In step f) at least one αβ-unsaturated carbonyl compound having at least one permanent cationic group is added to the dispersion of microcapsules obtained in step e).

The cationization in step f) is generally performed at a temperature of at least 50° C., preferably 60° C., more preferably in a range of from 75° C. to 90° C. and in particular 85° C. to 90° C., in order to ensure sufficiently rapid reaction progress.

Thereby the pH of the resulting mixture is preferably adjusted 7.

Here, it may be preferred to increase the temperature continuously or in stages (e.g. in each case by 10° C.) the reaction is essentially complete. Afterwards, the dispersion may cooled down to room temperature (21° C.).

The reaction time typically depends on the reaction amount and temperature used. The period of time for the cationization is ranging from a few minutes to several hours. Usually, cationization is established between ca. 60 minutes to 6 h or up to 8 h at the temperatures defined above.

In a particular embodiment of the invention, the amount of α,β-unsaturated carbonyl compound in polymerized form in the range from 1 to 50 by weight, more particularly in the range from 3 to 20% by weight, based on the total weight of the capsule shell of the microcapsules.

Suitable quaternization products of the α,β-unsaturated carbonyl compound, which are chemically bonded to the microcapsules, are selected from quaternized esters of α,β-ethylenically unsaturated mono- and dicarboxylic acids with amino alcohols which may be mono- or dialkylated on the amine nitrogen; quaternized amides of α,β-ethylenically unsaturated mono- and dicarboxylic acids with diamines having at least one primary or secondary amino group; quaternized N,N-diallylamine, quaternized N,N-diallyl-N-alkylamines and derivatives thereof, quaternized vinyl- and allyl-substituted nitrogen heterocycles and mixtures thereof.

Preferred quaternization products of the esters of α,β-unsaturated carbonyl compound are the quaternized esters of α,β-ethylenically unsaturated mono- and dicarboxylic acids with amino alcohols. Preferred amino alcohols are C₂-C₁₂-amino alcohols which are C₁-C₈-mono- or -dialkylated on the amine nitrogen. Suitable as acid component of these esters are, for example, acrylic acid, methacrylic acid, fumaric acid, maleic acid, itaconic acid, crotonic acid, maleic anhydride, monobutyl maleate and mixtures thereof. As acid component, preference is given to using acrylic acid, methacrylic acid and mixtures thereof.

Preferred quaternized esters of α,β-unsaturated carbonyl compound are the quaternization products of

N-methylaminoethyl (meth)acrylate,

N-ethylaminoethyl (meth)acrylate, N-(n-propyl)aminoethyl (meth)acrylate,

N-(tert-butyl)aminoethyl (meth)acrylate, N,N-dimethylaminomethyl (meth)acrylate,

N,N-dimethylaminoethyl (meth)acrylate, N,N-diethylaminomethyl (meth)acrylate,

N,N-diethylaminoethyl (meth)acrylate, N,N-dimethylaminopropyl (meth)acrylate,

N,N-diethylaminopropyl (meth)acrylate, N,N-dimethylaminocyclohexyl (meth)acrylate,

N,N-benzyl(methyl)aminoethyl (meth)acrylate and N,N-ethyl(methyl)aminoethyl (meth)acrylate.

Particular preference is given to the quaternization products of N,N-dimethylaminoethyl acrylate, N,N-dimethylaminoethyl methacrylate, N,N-benzyl(methyl)aminoethyl methacrylate, N,N-ethyl(methyl)aminoethyl methacrylate and mixtures thereof.

In a very specific execution, quaternization products of the esters of α,β-unsaturated carbonyl compound are selected from methyl chloride-, dimethyl sulfate-, ethyl-methyl sulfate-, diethyl sulfate-, methyl p-toluenesulfonate-quaternized N,N-dimethylaminoethyl (meth)acrylate N,N-benzyl(methyl)aminoethyl (meth)acrylate and N,N-ethyl(methyl)aminoethyl (meth)acrylate.

Preferred quaternization products of esters of α,β-unsaturated carbonyl compound are N,N,N-benzyl-dimethyl-[2-(2-methylprop-2-enoyloxy)ethyl]ammonium chloride (methacryloyl-oxyethyl-dimethyl-benzyl-ammoniumchloride), N,N,N-ethyl-dimethyl42-(2-methylprop-2-enoyloxy) ethyl]ammonium ethyl sulfate (methacryloyl-oxyethyl-dimethylethyl-ammonium-ethylsulfate), N,N,N-ethyl-dimethyl-[2-(2-methylprop-2-enoyloxy)ethyl]ammonium-4-methylbenzenesulfonate (methacryloyl-oxyethyl-trimethyl-ammonium-p-toluenesulfonate (methacryloyl-oxyethyl-trimethyl-ammonium-p-toluenesulfonate), N,N,N-trimethyl-[2-(2-methylprop-2-enoyloxy)ethyl]ammonium chloride (methacryloyl-oxyethyl-trimethyl-ammoniumchlorid) and N,N,N-trimethyl42-(2-methyl-prop-2-enoyloxy)ethyl]ammonium methyl sulfate (methacryloyl-oxyethyl-trimethyl-ammonium-methylsulfate).

Suitable are additionally the quaternization products of the amides of the aforementioned α,β-ethylenically unsaturated mono- and dicarboxylic acids with diamines having at least one primary or secondary amino group. Preference is given to diamines having one tertiary amino group and one primary or secondary amino group.

Examples of preferred quaternization products of the amides of α,β-unsaturated carbonyl compound are the quaternization products of N-[tert-butylaminoethyl](meth)acrylamide, N-[2-(dimethylamino)ethyl]acrylamide, N-[2-(dimethylamino)ethyl]methacrylamide, N-[3-(dimethylamino)propyl]acrylamide, N-[3-(dimethylamino)propyl]methacrylamide, N-[4-(dimethylamino)butyl]acrylamide, N-[4-(dimethylamino)butyl]methacrylamide, N-[2-(diethylamino)ethyl]acrylamide, N-[4-(dimethylamino)cyclohexyl]acrylamide and N-[4-(dimethylamino)cyclohexyl]methacrylamide.

Particular preference is given to the quaternization products of N-[3-(dimethylamino)propyl]acrylamide and N-[3-(dimethylamino)propyl]methacrylamide.

In a very specific execution, quaternization products of the amides of α,β-unsaturated carbonyl compound are selected from of methyl chloride-, dimethyl sulfate-, ethyl-methyl sulfate-, diethyl sulfate-, methyl p-toluenesulfonate-quaternized N-[3-(dimethylamino)propyl]acrylamide and N-[3-(dimethylamino)propyl]methacrylamide. Preferred quaternization products of amides of α,β-unsaturated carbonyl compound are N,N,N-trimethyl43-(prop-2-enoylamino)propyl]ammonium chloride (3-acryloyl-aminopropyl-trimethylammonium chloride), N,N,N-trimethyl-[3-(2-methylprop-2-enoylamino)propyl]ammonium chloride (3-methacryloyl-aminopropyl]-trimethylammonium chloride) and N,N,N-trimethyl43-(2-methylprop-2-enoylamino)propyl]ammonium methyl sulfate (methacryloyl-aminopropyl-trimethyl-ammonium methylsulfate).

Suitable quaternization products of the α,β-unsaturated carbonyl compound are quaternized N,N-diallylamines and N,N-diallyl-N-alkylamines. Alkyl here is preferably C₁-C₂₄-alkyl. Preference is given to the quaternization products of N,N-diallyl-N-methylamine and N,N-diallyl-N,N-dimethylammonium compounds, such as, for example, the chlorides and bromides. These include, in particular, quaternized N,N-diallyl-N-methylamine.

Suitable quaternization products of the α,β-unsaturated carbonyl compound are also quaternized vinyl- and allyl-substituted nitrogen heterocycles such as 2- and 4-vinylpyridine, 2- and 4-allylpyridine.

The permanent cationic groups of α,β-unsaturated carbonyl compound are preferably nitrogen-containing groups, such as primary, secondary and tertiary amino groups, and quaternary ammonium groups. The nitrogen-containing groups are quaternary ammonium groups. Charged cationic groups can be produced from the amine nitrogens either by protonation or by quaternization with acids or with alkylating agents. These include, for example, carboxylic acids, such as lactic acid, or mineral acids, such as phosphoric acid, sulfuric acid and hydrochloric acid, or as alkylating agents C₁-C₄-alkyl halides or sulfates, such as ethyl chloride, ethyl bromide, methyl chloride, methyl bromide, dimethyl sulfate, diethyl sulfate and benzyl chloride. Quaternization of the compounds used to modify the shell of the microcapsules with permanent cationic groups employed for the formation of the microcapsules according to the invention takes place before forming the microcapsules. Consequentely, the reaction of the shell material of the microcapsules with the α,β-unsaturated carbonyl compound having at least one permanent cationic group leads to the formation of microcapsules, wherein the shell of the microcapsules contains at least one permanent cationic group, which is covalently bonded to the shell.

In a further embodiment it is possible to employ a dispersion aid or a stabilization agent such as hydroxyalkylcelluloses, starches, acrylate polymers, copolymersalkylenglycoles, alkylenglycolmono(C₁-C₄-alkyl)ethers, alkylenglycoldi(C₁-C₄-alkyl)ethers, polyalkylenglycoles, polyalkylenglycolemono(C₁-C₄-alkyl)ethers, polyalkylenglycoledi(C₁-C₄-alkyl)ethers and mixtures thereof.

In addition to hydroxyalkylcelluloses, the microcapsule dispersion of the invention may comprise at least one further stabilizing agent which is different from hydroxyalkylcelluloses.

The relation to hydroxyalkylcellulose the term “alkyl” is preferably defined as linear or branched C₁-C₆ alkyl. Examples of C₁-C₆-alkyl are CH₃, C₂H₅, n-propyl, CH(CH₃)₂, n-butyl, CH(CH₃)-C₂H₅, CH₂-CH(CH₃)₂, C(CH₃)₃, n-pentyl, 1-methylbutyl, 2-methylbutyl, 3-methylbutyl, 2,2-dimethylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl or 1-ethyl-2-methylpropyl, preferably methyl, ethyl, n-propyl, 1-methylethyl, n-butyl, 1,1-dimethylethyl, n-pentyl or n-hexyl.

Examples of C₂-C₆-hydroxyalkyl groups are 2-hydroxyethyl, 2- and 3-hydroxypropyl, 1-hydroxyprop-2-yl, 3- and 4-hydroxybutyl, 1-hydroxybut-2-yl, 5-hydroxypentyl, 6-hydroxyhexyl. Preferred is 2-hydroxyethyl.

Preferred is hydroxyalkylcellulose, wherein alkyl is a C₁-C₄-alkyl, particularly hydroxyethylcellulose. Suitable hydroxyalkylcelluloses can be prepared by alkoxilation of a cellulose material by known methods. Thus, a cellulose can be reacted with ethylene oxide and/propylene oxide. The amount of alkylene oxide is preferably about 0.01 to 5 moles, more preferably about 0.02 to 3.5 moles, especially 0.05 to 2.5 per mole of glucose repeat units in the employed cellulose.

Preferably, the hydroxyalkylcellulose has a degree of polymerization (DP) of 10 to 5000, preferably 20 to 3000, in particular 30 to 1000.

Preferably, the hydroxyalkylcellulose has a degree of substitution with respect to hydroxyalkyl groups (DS) of from 0.01 to 3, more preferably 0.02 to 2, especially 0.02 to 1.5.

Preferred commercially available hydroxyalkylcelluloses are the NatrosolTM trademarks and especially preferred Natrosol™ 250 (CAS-Nr. 9004-62-0) of Herkules Incorporated.

In a particular embodiment of the invention, the amount of hydroxyalkylcellulose employed in the dispersion is in the range from 0.05% by weight to 1.2% by weight, more particularly in the range from 0.05% by weight to 0.6% by weight, based on the total weight of the dispersion.

Provided hydroxyalkylcellulose is employed as a stabilizing agent, additional stabilizing agents may also be employed. Examples of suitable additional stabilization agents are starches, acrylate homopolymers or acrylate copolymers.

Preferred commercially available starches are sold by National starch, under the trademark National 465, Purity W or starch B990.

Preferred commercially available acrylate polymers or copolymers are sold by BASF SE under the trademark Tinovis® CD, Ultragel® 300 and Rheocare® TTA.

When additional stabilizing agents are employed, they may be used in an amount of about 0.1% by weight to about 5.0% by weight, particularly 0.5% by weight to 4% by weight and more particularly 1% to 3% by weight, based on the total weight of the dispersion.

The stabilizing agent, in particular hydroxyalkylcellulose, is preferably added to the dispersion once the microcapsules are formed. It is not preferred to add the stabilizing agent, in particular hydroxyalkylcellulose, during the formation of the microcapsules.

In a special embodiment, the hydroxyalkylcellulose is added to the microcapsule dispersion in combination with at least one dispersion aid. Examples of suitable dispersion aids are alcohols, polyols, mono- and dialkyether of polyols, oils and mixtures thereof.

Suitable dispersion aids are alkylenglycols, alkylenglycolmono(C₁-C₄-alkyl)ethers, alkylenglycoldi(C₁-C₄-alkyl)ethers, polyalkylenglycoles, polyalkylenglycolemono(C₁-C₄-alkyl)ethers, polyalkylenglycoledi(C₁-C₄-alkyl)ethers and mixtures thereof.

The dispersion aid is preferably selected from methanol, ethanol, n-propanol, isopropanol, n-butanol, ethylenglycol, ethylenglycolmono(C₁-C₄-alkyl)ethers, ethylenglycoldi(C₁-C₄-alkyl)ethers, 1,2-propylenglycol, 1,2-propylenglycolmono(C₁-C₄-alkyl)ethers, 1,2-propylenglycoldi(C₁-C₄-alkyl)ethers, glycerin, polyglycerines and mixtures thereof.

Preferred dispersion aids are glycerine or propandiol.

A further aspect of the invention relates to the process according to the invention, wherein the obtained microcapsules, as described above, may be dried to provide microcapsules in solid form, preferably in form of a powder.

### Step g)

In another embodiment, the process according to the invention comprising in addition step g), wherein microcapsules dispersion obtained in step f) is subjected to a drying.

Drying in the sense of the invention means removing solvents which may present in the dispersion. The core material of the microcapsules still remains encapsulated. That means the dried microcapsule composition or microcapsules comprise at least one perfume ingredient.

The microcapsules or dispersion of the microcapsules may be dried using techniques known in the art. For example, the solid capsules can be isolated by filtration and dried. Drying of the isolated capsules may be performed by heating, e.g. in an oven or by contact with a heated gas stream.

Preferably, drying of the dispersion is carried out by spray drying or fluid-bed drying.

Spray drying techniques and apparatus are well known in the art. A spray-drying process pushes suspended capsules through a nozzle and into a drying chamber. The capsules may be entrained in a fluid (such as air) that moves inside of a drying chamber. The fluid (which may be heated, for example at a temperature of 150 and 120° C., more preferably between 170° C. and 200° C., and still more preferably between 175° C. and 185° C.) causes the liquid to evaporate, leaving behind the dried capsules which can then be collected from the process equipment and further processed.

It is conventional to mix spray dried capsules with flow aids to produce a flowable powder that are not susceptible to caking. Flow aids include silicas or silicates, such as precipitated, fumed or colloidal silicas; starches; calcium carbonate; sodium sulphate; modified cellulose; zeolites; or other inorganic particulates known in the art.

It is quite common, given the high temperatures and impaction forces encountered during a spray drying procedure, for core shell capsules to lose some of their core material.

Furthermore, it may not be possible to work at sufficiently high temperatures for a sufficiently long period of time to drive off all moisture from the dispersion, without compromising the thermal stability of the capsules. Accordingly, the polyurea capsules emerging from a spray-drying process, as herein described, may contain small amounts of surface oil as well as residual moisture.

If the microcapsules of the present invention are intended to be stored in the form of a dispersion, the pH of the dispersion is adjusted to a level of about 5 to 10. This may be achieved with the addition to an alkaline dispersion of a suitable acid, such as citric acid or formic acid.

The microcapsule dispersion can be prepared continuously or batchwise, preferably batchwise.

In a further embodiment, the dispersion of the microcapsules may contain non-encapsulated, i.e. free perfume ingredients, external of the capsules in the aqueous dispersion.

It is likewise possible for the ingredients of the core to migrate from the core of the microcapsules.

In a further embodiment of the invention, the dispersion of the microcapsules comprises at least one preservative in order to prevent microbial contamination of the microcapsules. The preservative may be encapsulated and/or it may be contained in the aqueous suspending medium of the dispersion.

Suitable preservatives include quaternary compounds, biguanide compounds, ethylhexylglycerin, caprylyl glycol, phenezhyl alcohol, propandiol, undecyl alcohol, tocopherol and mixtures thereof.

Non-limiting examples of quaternary compounds include benzalkonium chlorides and/or substituted benzalkonium chlorides, di(C₆-C₁₄)alkyl di short chain (C₁-₄ alkyl and/or hydroxyalkl) quaternary, N-(3-chloroallyl) hexaminium chlorides, benzethonium chloride, methylbenzethonium chloride, cetylpyridinium chloride, diester quaternary ammonium compounds and mixtures thereof.

Preferred commercially available benzalkonium chlorides are sold by Lonza under the trademark Barquat(R), Maquat(R) trademarks from Mason, Variquat(R) trademarks from Witco/Sherex and Hyamine(R) trademarks from Lonza.

Preferred commercially available di(C₆-C₁₄)alkyl short chain (C₁-₄ alkyl and/or hydroxyalkyl) quaternary are sold by Lonza under the trademark Bardac(R).

Preferred commercially available N-(3-chloroallyl) hexaminium chlorides are sold by Dow under the trademark Dowicide(R) and Dowicil(R).

Preferred commercially available benzethonium chlorides are sold by Rohm & Haas under the trademark Hyamine(R).

Preferred commercially available methylbenzethonium chlorides are sold by Rohm & Haas under the trademark Hyamine(R) 10*.

Preferred commercially available cetylpyridinium chlorides are sold by Merrell Labs under the trademark Cepacol chloride®.

Examples of preferred dialkyl quaternary compounds are di(C₈-C₁₂)dialkyl dimethyl ammonium chlorides.

Preferred commercially available dialkyl quaternary and dioctyldimethylammonium chlorides are sold by Lonza under the trademark Bardac(R) 22 and (Bardac(R) 2050).

The quaternary compounds useful as cationic preservatives and/or antimicrobial agents herein are preferably selected from the group consisting of dialkyldimethylammonium chlorides, alkyldimethylbenzylammonium chlorides, dialkylmethylbenzylammonium chlorides, and mixtures thereof. Other preferred cationic antimicrobial actives useful herein include diisobutylphenoxyethoxyethyl dimethylbenzylammonium chloride and (methyl)diisobutylphenoxyethoxyethyl dimethylbenzylammonium chloride (i.e. methylbenzethonium chloride).

Preferred commercially available quaternary compounds are sold by Rohm & Haas under the trademark Hyamine(R) 1622.

Preferred commercially available preservatives are sold by Schülke under the trademark Sensiva® PA20, Sensiva® PA40, Sensiva® SC10, Sensiva® SC50.

The microcapsules and dispersion of microcapsules as defined above can be used in a large number of different applications.

A preferred embodiment of the invention is the use of the microcapsules or of microcapsules dispersion according to the invention for:
a personal care composition, an air care composition, a home care composition or a laundry care composition.

### EXAMPLES

The following examples are intended to further illustrate the present invention without limiting its scope in any way.

### Analytics:

The volume average particle size is measured by light scattering measurements using a Malvern 2000S instrument and the Mie scattering theory, e.g. Mictrotrac nanotrac 250.

### Preparation:

### Example 1

### Cationic PU Microcapsules with Methacryloyl-Oxyethyl-Trimethyl-Ammoniumchlorid (QDM) Cationic Molecule Covalently Grafted

A premix (I) was prepared from 50 g of polyvinylpyrrolidone having a K value of 90 (PVP Kolloidon® 90) and 1169 g of water and adjusted to a pH of 10.0 using aqueous sodium hydroxide solution (5% strength by weight). Premix (II) was prepared from 500 g of a perfume, 58 g of dicyclohexylmethane diisocyanate (Desmodur® W) and 20 g of anionic HDI oligomer (Bayhydur® XP 2547). These two premixes were combined and emulsified with the help of a Mig stirrer for 30 minutes at room temperature at a speed of 700 rpm. The pH of the emulsion was then adjusted to 8.5 using aqueous sodium hydroxide solution (5% strength by weight). Then, at room temperature and with stirring at 700 rpm, a solution of 20 g of polyethyleneimine (Lupasol® PR8515) in 147 g of water was added over the course of 1 minute. The reaction mixture was then subjected to the following temperature program: heating to 60° C. in 60 minutes, maintaining this temperature for 60 minutes, then 60 minutes at 70° C., 60 minutes at 80° C. and finally 60 minutes at 85° C. 2.4 g of methacryloyl-oxyethyl-trimethyl-ammoniumchlorid (QDM) was then added to the dispersion and the mixture was left at 85° C. for additional 5 h. The mixture was then cooled down to room temperature. The desired microcapsule dispersion with a particle size distribution according to the following values: d 50=11 μm and d 90=22 μm was obtained.

Zeta potential (mV):+6

### Comparative Example

### Example C

### Neutral Polyurea Microcapsules

A premix (I) was prepared from 50 g of polyvinylpyrrolidone having a K value of 90 (PVP Kolloidon® 90) and 1169 g of water and adjusted to a pH of 10.0 using aqueous sodium hydroxide solution (5% strength by weight). Premix (II) was prepared from 500 g a perfume, 58 g of dicyclohexylmethane diisocyanate (Desmodur® W) and 20 g of anionic HDI oligomer (Bayhydur® XP 2547). These two premixes were combined and emulsified with the help of a Mig stirrer for 30 minutes at room temperature at a speed of 700 rpm. The pH of the emulsion was then adjusted to 8.5 using aqueous sodium hydroxide solution (5% strength by weight). Then, at room temperature and with stirring at 700 rpm, a solution of 12 g of polyethyleneimine (Lupasol® PR8515) in 147 g of water was added over the course of 1 minute. The reaction mixture was then subjected to the following temperature program: heating to 60° C. in 60 minutes, maintaining this temperature for 60 minutes, then 60 minutes at 70° C., 60 minutes at 80° C. and finally 60 minutes at 85° C. The mixture was then cooled to room temperature. The desired microcapsule dispersion with a particle size distribution according to the following values: d 50=10 μm and d 90=21 μm was obtained.

Zeta potential (mV):+1

1. A microcapsule composition, wherein the shell of the microcapsules comprises at least one polyurea which contains at least one permanent cationic group, which is covalently bonded to the shell and the core comprises at least one perfume ingredient, and wherein the shell of the microcapsules does not contain guanidinium groups.

2. The microcapsule composition according to claim 1, wherein the cationic group is selected from nitrogen-containing groups and phosphorus-containing groups, preferably quaternary ammonium groups.

3. The microcapsule composition according to claim 1, wherein the microcapsule comprises at least one α,β-unsaturated carbonyl compound, heaving at least one permanent cationic group, in polymerizied form which is selected from:
a) the esters of α,β-ethylenically unsaturated mono- and dicarboxylic acids with amino alcohols,
b) amides of α,β-ethylenically unsaturated mono- and dicarboxylic acids with diamines which have at least one primary or secondary amino group,
c) N,N-diallylamine, N,N-diallyl-N-alkylamines and derivatives thereof,
d) vinyl- and allyl-substituted nitrogen heterocycles and mixtures thereof.

4. The microcapsule composition according to claim 3, wherein the amount of the α,β-unsaturated carbonyl compound in polymerized form is from 1 to 50% by weight based on the total weight of the capsule shell of the microcapsules.

5. The microcapsule composition according to claim 1, wherein the microcapsules have a volume average diameter of 2 to 90 μm.

6. The microcapsule composition according to claim 1, wherein the core of the microcapsule is 60 to 97% by weight and the shell of the microcapsule is 40 to 3% by weight, based on the total weight of the microcapsule.

7. The microcapsule composition according to claim 1 in the form of an aqueous dispersion.

8. The microcapsule composition according to claim 1, wherein the microcapsules have a zeta potential from 6 to 100 mV.

9. A process of preparing a microcapsule composition, wherein the shell of the microcapsules comprises at least one polyurea which contains at least one cationic group covalently bound to the shell, and the core comprises at least one perfume ingredient, the process comprising the steps of:
a) providing a premix (I) comprising at least one protective colloid in an aqueous solution,
b) providing a premix (II) comprising a lipophilic phase containing at least one polyisocyanate and the at least one perfume ingredient,
c) mixing premix (I) and premix (II) until an emulsion (III) is formed,
d) adding an aqueous solution (IV) containing at least one polyfunctional amine to the emulsion formed in step c),
e) forming a dispersion of microcapsules by heating the mixture obtained in step d) to a temperature of at least 50° C. and
f) adding at least one α,β-unsaturated carbonyl compound having at least one permanent cationic group.

10. The process according to claim 9, additionally comprising the step of:
g) subjecting the microcapsule obtained in step f) to drying.

11. The process according to claim 9, wherein the premix (II) comprises at least one nonionic polyisocyanate (A) and at least one anionically modified isocyanate (B).

10. The process according to claim 11, wherein the weight ratio of isocyanates (A) and (B) is in the range from of 10:1 to 1:10.

11. The process according to claim 10, wherein the polyfunctional amine especially comprises or consists of at least one polyethyleneimine.

12. A microcapsule composition obtainable by the process of claim 10.

13. (canceled)

14. (canceled)

15. The process of claim 11, wherein the anionically modified isocyanate (B) contains at least one sulfonic acid group in the molecule.

16. The process of claim 15 wherein the weight ratio of isocyanates (A) and (B) is in the range of 5:1 to 1:5.

17. The process of claim 10 wherein the weight ratio of isocyanates (A) and (B) is in the range of 3:1 to 1:1.

18. A personal care composition, air care composition, home care composition or a laundry care composition comprising microcapsules according to claim 1.

19. A personal care composition, air care composition, home care composition or a laundry care composition comprising microcapsules prepared by the process of claim 9.
